(19) United States
(12) Patent Application Publication
(10) Pub. No.: US 2013/0304521 A1
(43) Pub. Date: Nov. 14, 2013

(54) Ticket Exchanger

(71) Applicant: David M. Aird, Elkridge, MD (US)

(72) Inventor: David M. Aird, Elkridge, MD (US)

(21) Appl. No.: 13/470,629

(22) Filed: May 14, 2012

(51) Int. Cl. G06Q 10/02

(52) U.S. Cl. 705/5

(57) ABSTRACT

A portable processing device capable of communicating wirelessly with one or more other processing devices is provided. The portable processing device may display information regarding at least one venue within a predetermined distance of a current location of the portable processing device. A user may select a venue and may request and receive, via the portable processing device, information regarding one or more tickets to an event in progress at the selected venue. The portable processing device may obtain and display information regarding available tickets from users of other portable processing devices located within the predetermined distance of the selected venue. The user may offer, via the portable processing device, an amount of money, a ticket swap, or nothing for one or more of the available tickets. The portable processing device may permit the user to rate a second user, who is a party to a finalized deal.

### BACKGROUND

While attending an event, including, but not limited to, a sporting event, a concert a play, or another type of event or performance, one may leave the event early, thereby leaving an empty seat at the event. Others attending the event may desire to obtain other, possibly better, seats at the event, while the event is in progress, but may hesitate to move to empty seats because they may be challenged by a venue employee and may be asked to leave the event, or at the very least, may suffer embarrassment. Thus, there is a need for those attending an event to easily publicize availability of one or more of their tickets and/or to make offers regarding others' publicized available tickets.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a system, including a portable processing device, is provided. The portable processing device may be provided with, or may determine, a current location. Some embodiments may permit the user to manually input current location information of the portable processing device. Information regarding at least one venue within a predetermined distance of the current location may be obtained and displayed by the portable processing device. In some embodiments, information regarding venues not having an event in progress may be filtered out of the information regarding the at least one venue. A user interface may be provided for a user to select a venue from the displayed information regarding the at least one venue when the at least one venue includes two or more venues. The portable processing device may then display information regarding the selected venue and an associated event. The portable processing device may display information regarding available tickets from users of other portable processing devices who are attending an event at a same venue. The user may offer money or his or her own tickets in exchange for one or more available tickets from another user of another portable processing device attending the event.

In some embodiments, the portable processing device may permit a user to input seat or ticket information only while an event is in progress at a venue associated with a current location of the portable processing device. A venue may be associated with a current location of the portable processing device when the portable processing device is determined to be within a predetermined distance of the venue. The input seat or ticket information provided by the user may be published, or made available, to other portable processing devices at the venue or within the predetermined distance of the venue.

Some of the embodiments may include at least one server. The server may receive the seat or ticket information provided by the user of the portable processing device and may make the received seat or ticket information available to other portable processing devices located within the predetermined distance of the venue. Several embodiments may make the received seat or ticket information available to the other portable processing devices only when an event is in progress at the venue. After finalizing a deal, a user may rate a second user who is a party to the finalized deal. A user rating report may be generated and made available to users of portable processing devices.

### DRAWINGS

In order to describe the manner in which the above-recited and other advantages and features can be obtained, a more particular description is described below and will be rendered by reference to specific embodiments thereof which are illustrated in the appended drawings. Understand that these drawings depict only typical embodiments and are not therefore to be considered to be limiting of its scope. Implementations will be described and explained with additional specificity and detail through the use of the accompanying drawings.

FIG. 1 illustrates an exemplary environment in which various embodiments may be implemented.

FIG. 2 is a functional block diagram of a processing device that may be used in the embodiments.

FIGS. 3-17 are exemplary display screens, which may be displayed by a portable processing device consistent with the subject matter of this disclosure.

FIG. 18 is a state transition diagram illustrating exemplary transitioning of states in some embodiments.

FIGS. 19-33 are flowcharts illustrating exemplary processing in various embodiments consistent with the subject matter of this disclosure.

### DETAILED DESCRIPTION

### Overview

Embodiments consistent with the subject matter of this disclosure are directed to a portable processing device capable of communicating with other processing devices. The portable processing device may include a smart phone, a personal digital assistant (PDA), a tablet computing device, a notebook or laptop computing device, or another type of portable processing device.

The portable processing device may receive location information regarding a current location of the portable processing device. The portable processing device may obtain information regarding at least one venue within a predetermined distance of the current location of the processing device. In some embodiments, venues not having an event currently in progress may be filtered out from the information regarding the at least one venue within the predetermined distance of the current location. The portable processing device may then display information regarding the at least one venue and an associated event and may provide a user interface for a user to select a venue from the at least one venue. The user may then request and display, via the portable processing device, information regarding available tickets from other users attending the event. The user may also provide information regarding availability of his or her ticket(s). Via the portable processing device, the user may sell, give away, or swap his or her ticket(s) for one or more tickets of another user of another processing device at the selected venue.

In some embodiments, the user may be permitted to input seat or ticket information only at a time while the event is occurring, or is in progress, at the selected venue while the processing device is located at the selected venue or within the predetermined distance of the selected venue. In other embodiments, the input seat or ticket information may be published, or made available to other portable processing devices at the venue, while the event is occurring, or is in progress, at the venue.

Some embodiments may provide a method by which a ticket date may be verified. The method may include capturing of an image of the one or more tickets via the portable processing device, sending, by the portable processing device, the captured image to another processing device or server, via a network, along with a request for verification, receiving a result of the verification, and informing a user of the portable processing device of a result of the verification.

Other embodiments may include a system having at least one server. The at least one server may include at least one processor, a communication interface for communicating with at least one portable processing device, and a memory having instructions recorded therein for the server to perform a method. The method may include receiving of seat information from a portable processing device located within a predetermined distance of a venue, providing the received seat information as an offer to one or more portable processing devices located within the predetermined distance of the venue, and receiving information regarding an acceptance of the offer from one of at least one other portable processing device, and providing instructions to the one of the at least one other portable processing device and the portable processing device from which the seat information, pertaining to the accepted, offer, was received.

### Exemplary Operating Environment

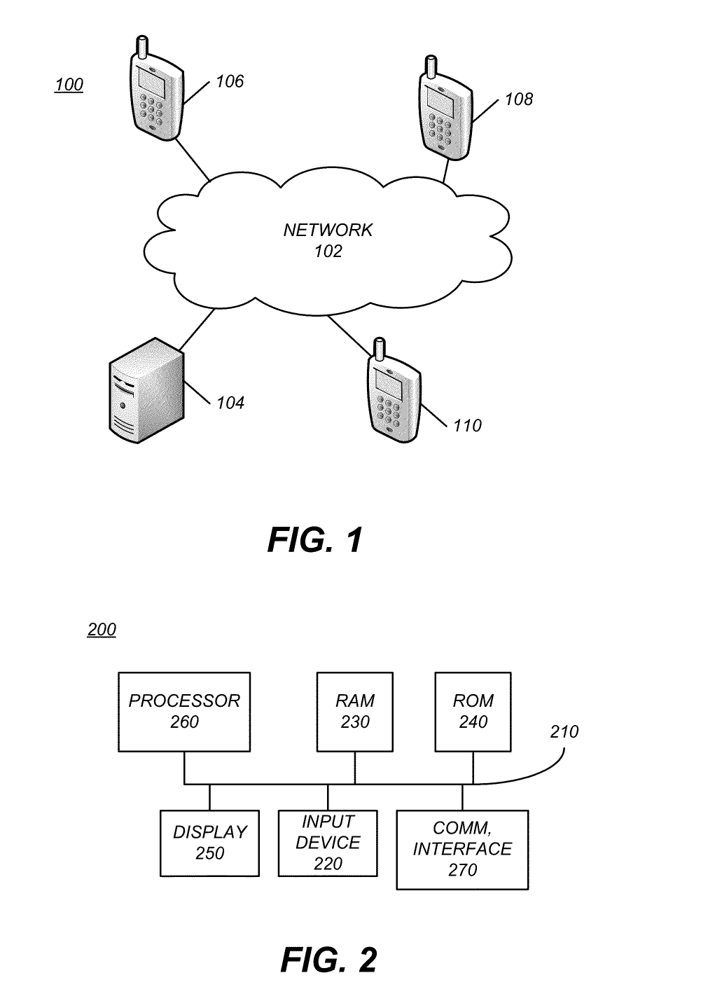

FIG. 1 illustrates an exemplary operating environment 100 in which embodiments consistent with the subject matter of this disclosure may operate. Operating environment 100 may include a network 102, one or more processing devices 104, which may include a server or a server farm, and a number of portable processing devices 106, 108, 110, which may communicate via network 102.

Network 102 may include one or more wired or wireless networks by which portable processing devices 106, 108, 110 may communicate with one another and with processing device 104. Network 102 may include a number of different types of networks which may include, but not be limited to, a mobile communication network, a packet switched data network, a public switched telecommunication network, as well as other types of networks. In some embodiments, network 102 may include the Internet.

Although operating environment 100 shows only one processing device 104 and only three portable processing devices, other operating environments may include a number of processing devices 104 and more or fewer portable processing devices 106, 108, 110.

### Exemplary Processing Device

FIG. 2 is a block diagram illustrating an exemplary processing device 200 that may be used to implement any of portable processing devices 106, 108, 110 and one or more processing devices 104 in various embodiments consistent with the subject matter of this disclosure.

Processing device 200 may be a server, a portable processing device, including, but not limited to a personal computer (PC), a laptop computer, a tablet computer, a PDA, a smart phone, or another type of processing device. Processing device 200 may include hardware, such as a processor 260, a bus 210, a memory, which may include a combination of random access memory (RAM) 230 and read only memory (ROM) 240, an input device 220, a display device 250 and a communication interface 270.

Processor 260 may include one or more conventional processors that interpret and execute instructions. RAM 230, or another type of non-transitory dynamic storage medium, may store information and instructions for execution by processor 260. RAM 230 or other non-transitory dynamic storage medium may store instructions as well as temporary variables or other intermediate information used during execution of instructions by processor 260. ROM 240, or another type of static storage medium, may store static information and instructions for processor 260. Communication interface 270 may include a transceiver for communicating with other processing devices via a network. When processing device 200 is used to implement a portable processing device, communication interface 270 may include a wireless transceiver.

Some embodiments of processing device 200 may further include a hardware logic component, including, but not limited to, an application specific integrated circuit (ASIC) (not shown) and/or a field programmable gate array (FPGA) (not shown) that may be combined with instructions in memory 230, 240 to cause processing device 200 to perform a method.

Input device 220 may include a keyboard, a pointing device, a touchscreen or other device for providing input. Display 250 may include a display or other device for outputting information.

Processing device 200 may communicate with other devices via a communication medium, which may include, but not be limited to, a propagated signal on a carrier wave and may perform functions in response to processor 260 executing sequences of instructions contained in a machine-readable storage medium. Such instructions may be read into a machine-readable storage medium for storing information for a non-transitory period of time. The machine-readable storage medium may include, but not limited to, RAM 230 or another dynamic storage medium, and ROM 240 or another static storage medium.

### Embodiments

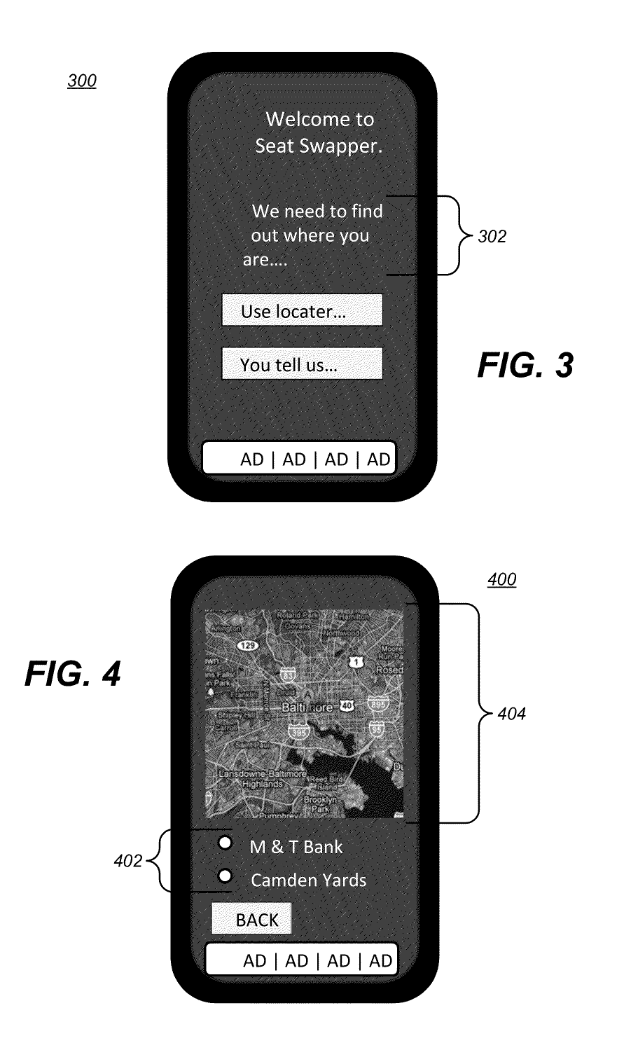

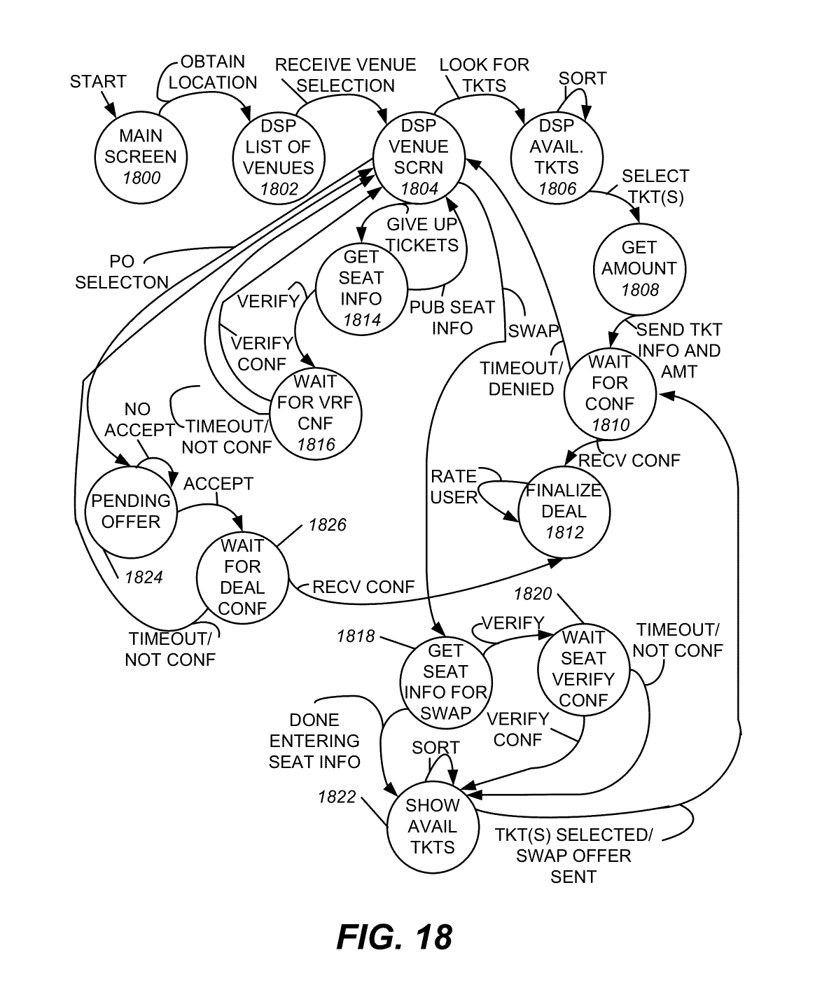

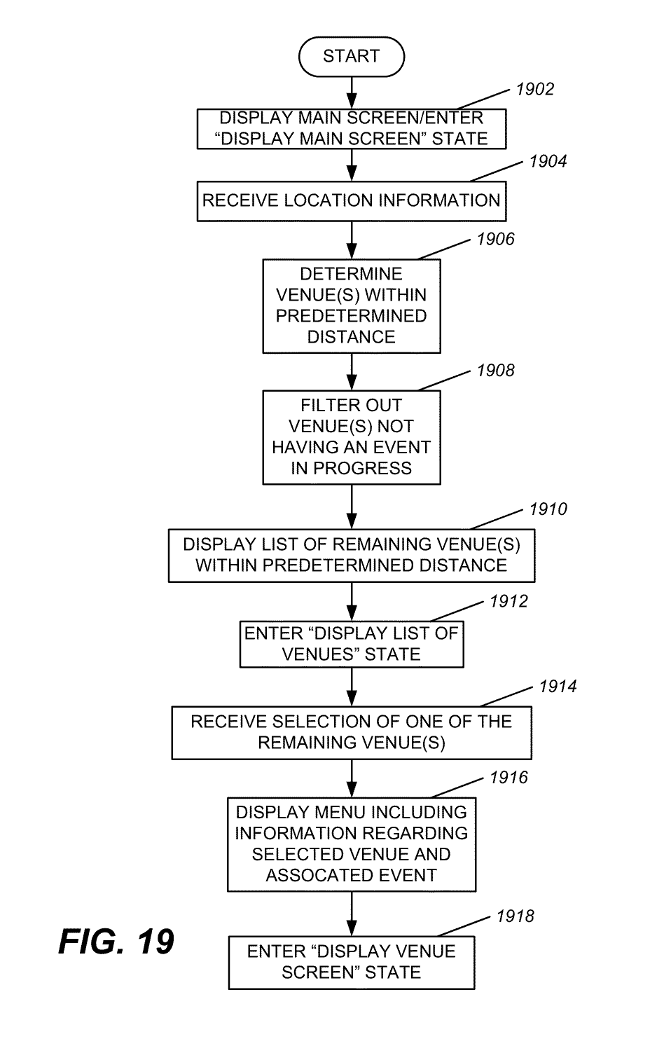

Various embodiments are explained with reference to exemplary display screens shown in FIGS. 3-17, an exemplary state transition diagram illustrated by FIG. 18, and flowcharts of FIGS. 19-33.

FIG. 19 is a flowchart of an exemplary process that may be executed by a portable processing device consistent with the subject matter of this disclosure. The process may begin with the portable processing device displaying a main screen and entering a “main screen” state (act 1802). This is illustrated in the state transition diagram of FIG. 18 by state 1800.

FIG. 3 shows an exemplary display screen 300, which may be displayed by the portable processing device while in the “main screen” state. Display screen 300 may display a prompt 302 for a user to indicate whether the portable processing device is to determine a current location or whether the user is to enter location information regarding the current location.

Referring back to FIG. 19, the portable processing device may receive the location information (act 1904). As indicated by display screen 300, the location information may be provided manually by the user or may be automatically determined (via a locator). In some embodiments, the locator may include a global positioning system with satellites that provide location information to the portable processing device. In other embodiments, the portable processing device may scan signals for unique signatures from at least one of a number of wireless fidelity (WiFi) access points and may either determine a current location based on the unique signatures of the scanned signals or may transmit scanned signal information to a second processing device, including, but not limited to a server, which may determine the current location based on the unique signatures and may transmit information including the current location to the portable processing device. In other embodiments, other methods may be employed to determine the current location of the portable processing device.

In some embodiments, one or more venues within a predetermined distance of the current location of the portable processing device may be determined (act 1906; FIG. 19). The predetermined distance may be 25 feet, 50 feet, or another suitable predetermined distance. Act 1906 may be performed by the portable processing device, the second processing device, or another processing device in communication with the portable processing device, which may further determine ones of the one or more venues not having an event in progress and may filter out the determined ones of the one or more venues from a list of the one or more venues within the predetermined distance to produce a list of remaining venue(s) (act 1908). The list of remaining venue(s) may be provided to the portable processing device, which may display the list of remaining venue(s) within the predetermined distance (act 1910) and may enter a “display list of venues” state (act 1912).

The state transition diagram of FIG. 18 illustrates the above through a state transition from “main screen” state 1800 to “display list of venues” state 1802 after the portable processing device obtains or determines the current location.

FIG. 4 illustrates an exemplary display screen 400, which displays an exemplary list of venues 402 and a map 404. The exemplary list of venues includes M & T Bank Stadium and Camden Yards. A displayed list of venues may include no venues or a number of venues.

The portable processing device may then receive a selection of a venue from the displayed list of venues (act 1914; FIG. 19). A user may select the venue by a number of different methods, including, but not limited to, touching a selection indicator next to a name of the venue displayed on the display screen, moving a displayed pointer via a control to a location of the selection indicator and pressing a hard or soft key, or other methods.

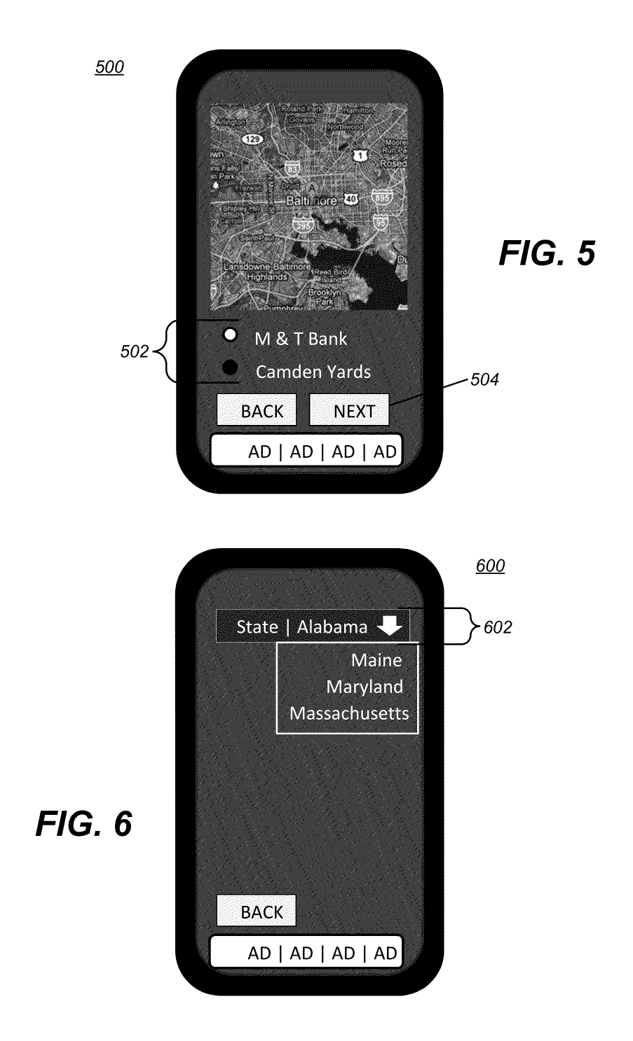

FIG. 5 illustrates an exemplary display screen 500 showing the exemplary displayed list of venues after selection of the Camden Yards venue. Note that a selection indicator 502 may have a different color than a corresponding selection indicator in FIG. 4, thereby acknowledging selection of the selected venue. The user may then confirm the selected venue by selecting a “next” indicator 504 via any one of a number of methods.

FIG. 18 illustrates the above by a state transition from the “display list of venues” state 1802 to “display venue screen” state 1804 after the portable processing device receives the selection of the selected venue.

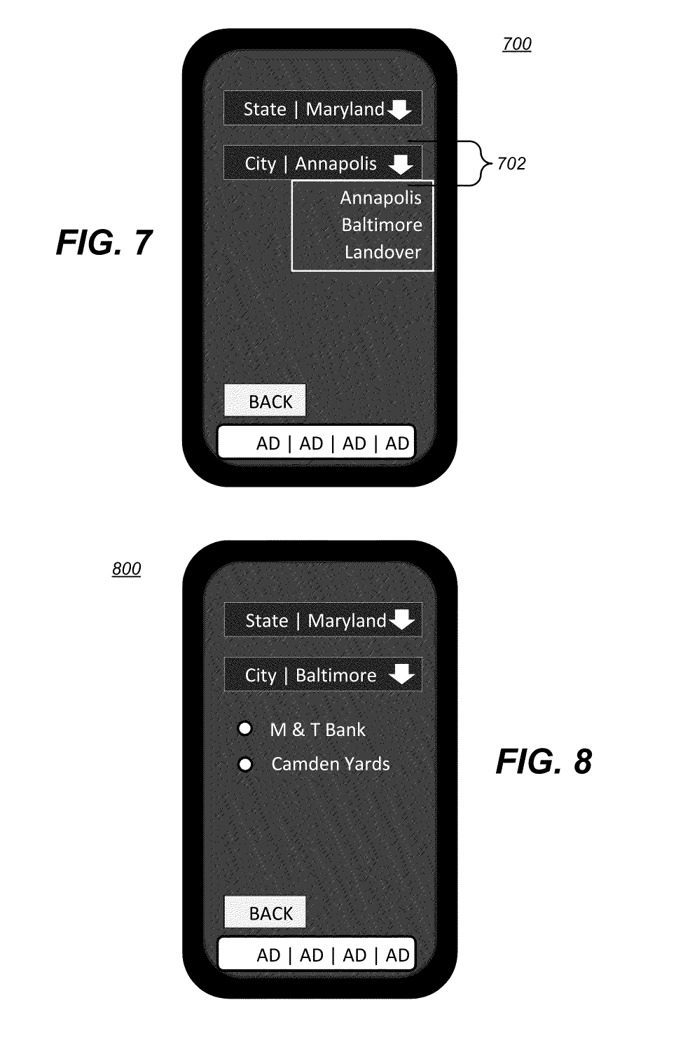

Referring back to exemplary display screen 300, if the user indicates a desire to manually enter a location by selecting a displayed indicator, such as, for example, “you tell us . . . ” shown in exemplary display screen 300, or another indicator, the user may be prompted to enter location information, including, but not limited to, state information as shown in exemplary display screen 600 (FIG. 6), and city information as shown in exemplary display screen 700 (FIG. 7). The user may provide the state information by typing a name of a state or by selecting a displayed state field 602, thereby causing a list of state names to be displayed, from which one of the displayed state names may be selected. Similarly, the user may provide the city information by typing a name of a city or by selecting a displayed city field 702, thereby causing a list of city names to be displayed from which one of the displayed city names may be selected.

After the state information and the city information is provided, the portable processing device may display one or more venues within the predetermined distance of a current location, as manually provided by the user. FIG. 8 illustrates exemplary display screen 800 after the user provided state information “Maryland” and city information “Baltimore”. Displays screen 800 displays a list of venues in the provided city and state, which in this example include M & T Bank Stadium and Camden Yards.

Referring back to FIG. 19, the portable processing device may display a menu including information regarding the selected venue and an associated event (act 1916) and may enter “display venue screen” state (act 1918).

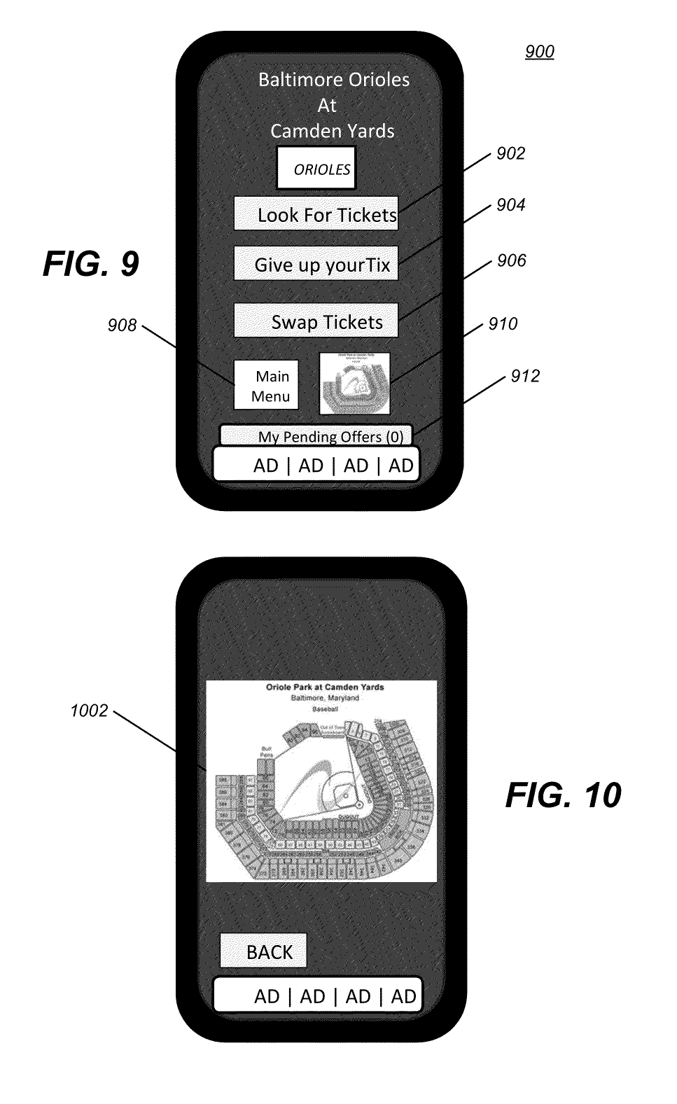

FIG. 9 illustrates exemplary display screen 900, which the portable processing device may display after receiving Camden Yards as the selected venue. The menu may include selectable items for looking for tickets 902, giving up a ticket 904 and swapping tickets 906. Selectable item 908 may be selected by a user when the user wishes to return to a main menu for determining or obtaining a current location, such as the menu illustrated by, for example, exemplary display screen 300 or another menu.

In various embodiments, a user may request and receive venue-specific information. For example, if a user selects selectable item 910, which may be a seating chart 1002 of the selected venue, an enlarged version of seating chart 1002 may be displayed, as is shown in FIG. 10. In other embodiments, other venue-specific information may be displayed, such as, for example, a roster of players at a sporting event at the selected venue, or other venue-specific information.

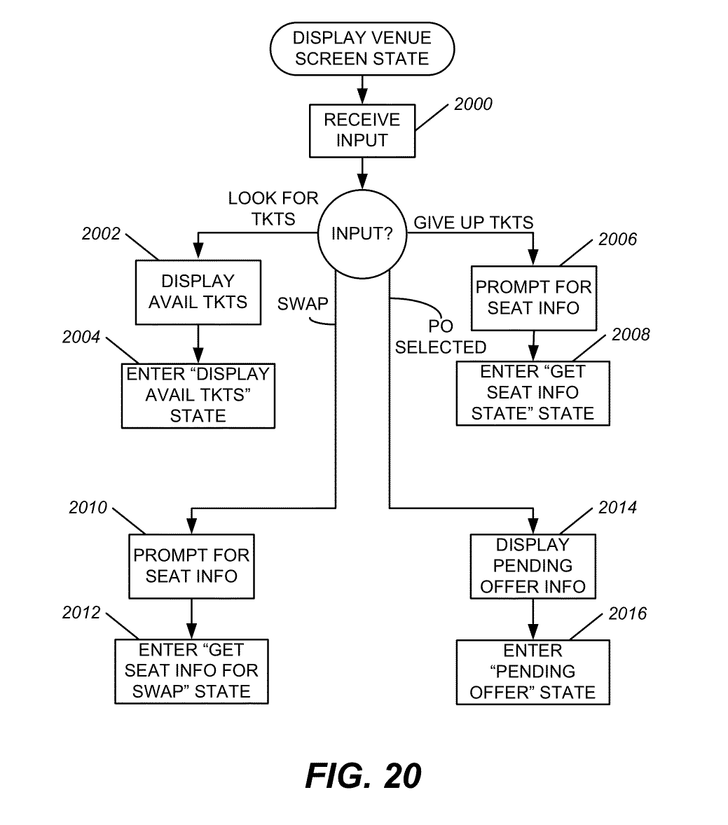

FIG. 20 is a flowchart illustrating exemplary processing, in various embodiments, with respect to the portable processing device receiving input from a user while in the “display venue screen” state. If the received input indicates that the user selected “look for tickets”, then the portable processing device may obtain and display information regarding available tickets (act 2002) and may enter “display available tickets” state (act 2004). In some embodiments, the portable processing device may request available ticket information for the venue from a server and may display the available ticket information after the portable processing device receives the available ticket information from the server.

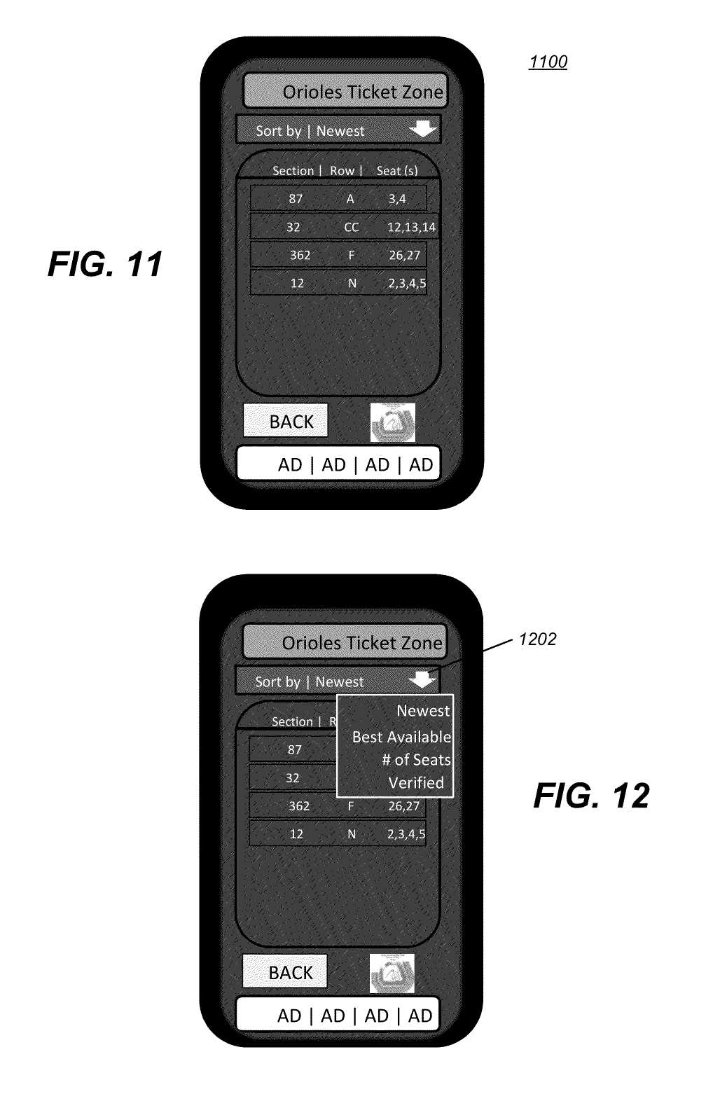

FIG. 11 illustrates an exemplary display screen 1100 that the portable processing device may display regarding information about available tickets. As shown in display screen 1100, information regarding a section, a row, and a seat number may be displayed. In other embodiments, other information regarding available tickets may be displayed.

FIG. 18 illustrates a state transition from the “display venue screen” state 1804 to the “display available tickets” state 1806 corresponding to the flowchart of FIG. 20 when an input indicating a selection of “look for tickets” is received.

If the received input indicates that the user selected “give up tickets”, then the portable processing device may prompt the user for seat or ticket information corresponding to tickets to be given up (act 2006). The portable processing device may then enter “get seat info” state (act 2008), as is shown by a state transition from the “display venue screen” state 1804 to the “get seat info” state 1814.

If the received input indicates that the user selected “swap tickets”, then the portable processing device may prompt the user for seat or ticket information corresponding to tickets to be given up, or swapped (act 2010). The portable processing device may then enter “get seat info for swap” state, as is shown by a state transition from the “display venue screen” state 1804 to the “get seat info for swap” state 1818.

If the received input indicates that the user selected “my pending offers” (see 912; FIG. 9), then the portable processing device display pending offer information regarding the user's available seat(s) (act 2014) and may then enter “pending offer” state, as is shown by a state transition from the “display venue screen” state 1804 to the “pending offer” state 1824. Exemplary display screen 900 shows zero offers pending. Exemplary display screen 1600 shows one offer pending (see 1602; FIG. 16).

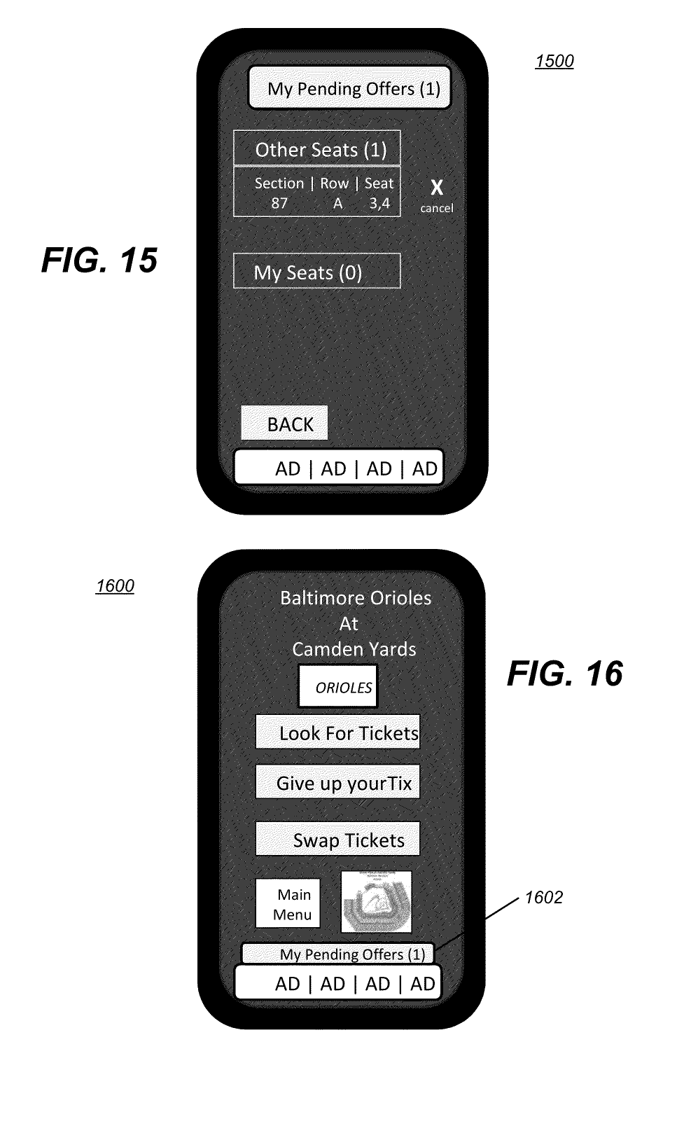

FIG. 15 illustrates exemplary display screen 1500, which may be displayed when the user selects “my pending offers”. The displayed information may include information regarding one or more seats or tickets that the user is willing to give up as well as offers made by the user regarding other seats or tickets at the venue. In exemplary display 1500, the display indicates that the user did not offer any seats or tickets to be given up and has executed a pending offer for two seats or tickets located in section 87, row A, seats 3 and 4.

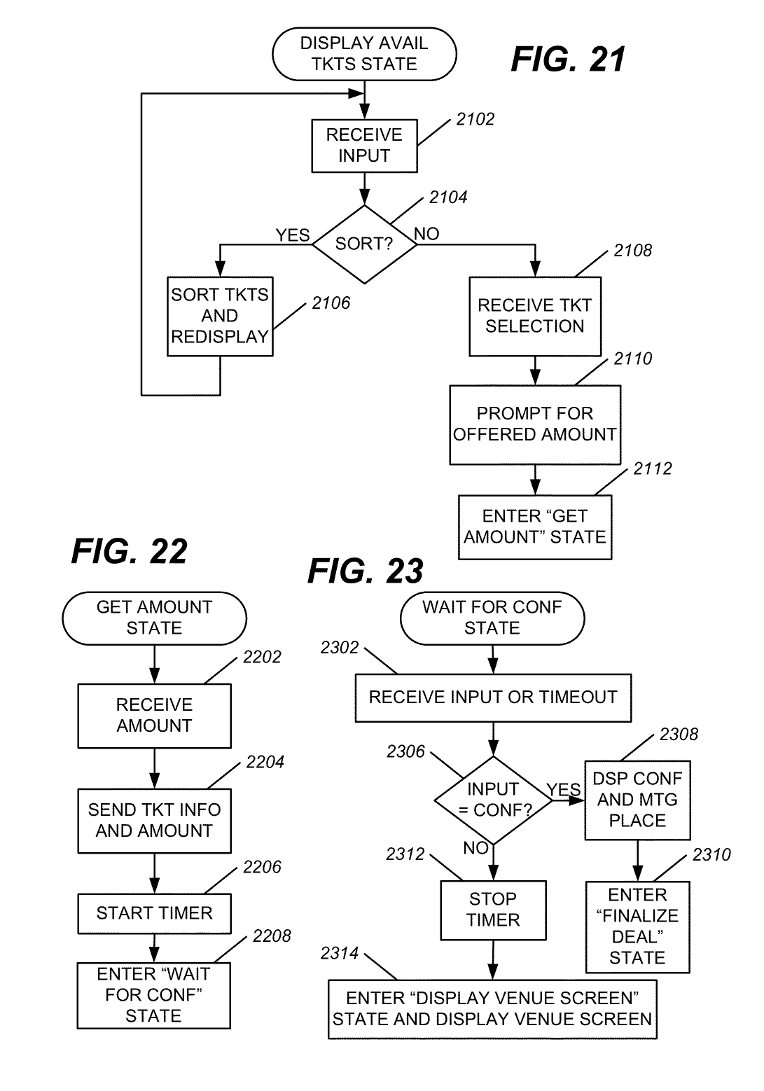

FIG. 21 is a flowchart illustrating exemplary processing, in various embodiments, with respect to the portable processing device receiving input from a user while in the “display available tickets” state. At act 2102, the portable processing device receives an input from the user. The portable processing device may then determine whether the received input indicates that the user selected “sort” and an order for sorting (act 2104). If the portable processing device determines that the received input indicates that the user selected “sort” and the order for sorting, then the portable processing device may sort and redisplay the information regarding the available tickets (act 2106).

While viewing the available tickets, the user may select a selectable sort item 1202, shown in FIG. 12, which may cause the portable processing device to display a pop-up menu listing various ways a listing of the available tickets may be sorted. The user may then make a selection of one of the various ways the listing of the available tickets may be sorted.

As shown in FIG. 12, exemplary ways in which the available tickets may be sorted may include listing newest tickets first, listing best available tickets first, listing based on a number of seats available, and listing verified seats before unverified seats, as will be explained later. The abovementioned ways for sorting are only exemplary. Numerous other ways for sorting the available tickets may be performed in other embodiments.

Returning to the flowchart of FIG. 21, if the processing device determines that the received input does not include an indication that the user selected “sort” and the order for sorting, then the portable processing device may assume that the user selected, by touching a screen or via another method, one of a number of displayed available tickets, may receive the ticket selection and may acknowledge the received ticket selection by highlighting the corresponding ticket selection or via another method (act 2108). The portable processing device may then prompt the user for an offered amount (act 2110). In some embodiments, a numerical amount may be manually entered in some combination of whole currency, including, but not limited to, dollars and cents. The amount may be entered via touch screen, numeric keypad, or some other method.

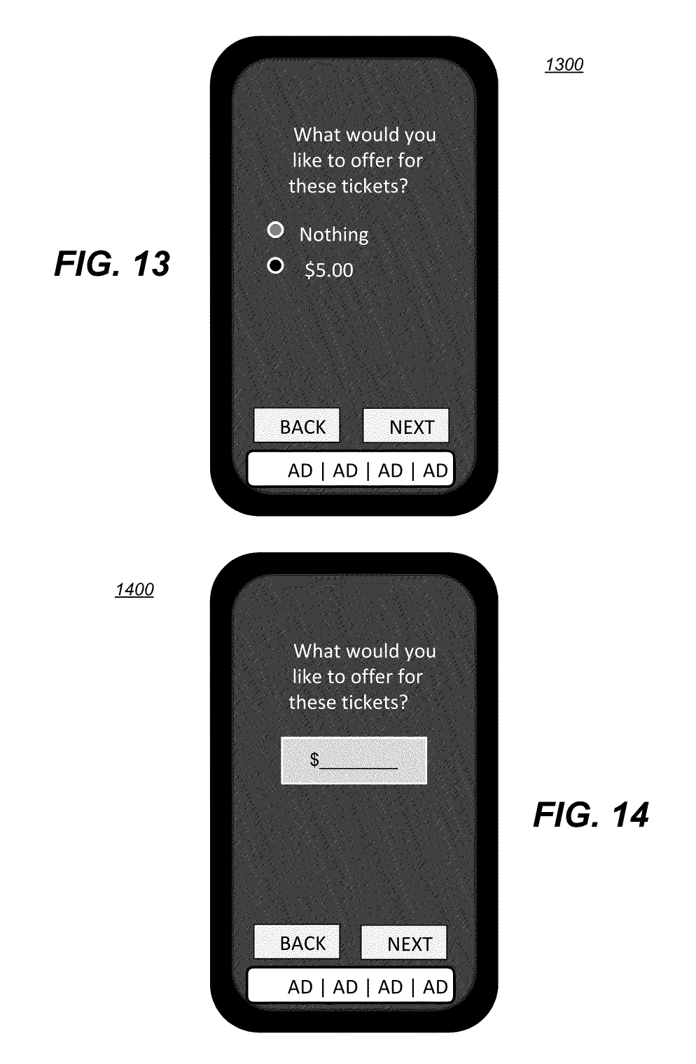

FIG. 13 illustrates exemplary display screen 1300, which shows a number of choices that the user may select to indicate an offered amount. FIG. 13 shows two choices, nothing and five dollars. In other embodiments, a display screen may display more than two choices. FIG. 14 illustrates exemplary display screen 1400 in another embodiment, in which the user may be prompted to enter an offered amount. The methods for entering an offered amount, shown by FIGS. 13 and 14, are only exemplary. In other embodiments, other methods may be employed by the user to enter an offered amount, including, but not limited to, speech input as well as other methods.

Returning to FIG. 21, after prompting the user to provide an offered amount, the portable processing device may enter “get amount” state (act 2112).

FIG. 18 illustrates the above via a state transition from the “display of available tickets” state 1806 to the “get amount” state 1808 when a ticket selection is received from the user.

FIG. 22 is a flowchart illustrating exemplary processing, in various embodiments, with respect to the portable processing device receiving input from the user while in the “get amount” state. The portable processing device may receive an indication of the offered amount for the selected ticket or tickets (act 2202). Next, the portable processing device may send ticket information and the offered amount (act 2204). In some embodiments, the portable processing device may send the ticket information and the offered amount to a portable processing device of a user who is offering the ticket or tickets. In other embodiments, the portable processing device may send the ticket information and the offered amount to another processing device, which may be a server. The server may forward the indication of the offered amount to the portable processing device of the user who is offering the ticket(s).

The portable processing device may then start a timer (act 2206) and may enter “wait for confirmation state” (act 2208) to wait for a confirmation of acceptance from the user who is offering the ticket or tickets. In some embodiments, the confirmation may be sent from the processing device of the user who is offering the ticket or tickets. In other embodiments, the confirmation may be sent from the server after the server receives the confirmation from the portable processing device of the user who is offering the ticket(s).

FIG. 18 illustrates the above by a state transition from the “get amount” state 1808 to the “wait for confirmation” state 1810 after the portable processing device sends the ticket information and the offered amount.

FIG. 23 is a flowchart illustrating exemplary processing while the portable processing device is in the “wait for confirmation” state. While in the “wait for confirmation” state, the portable processing device may receive input or an indication of a timeout (act 2302). The portable processing device may then determine whether the input or timeout is a confirmation (act 2306). If the portable processing device determines that the input or timeout is the confirmation from the portable processing device of the user offering the ticket(s), then the portable processing device may display a screen indicating that a confirmation has been received and a location where a deal concerning the ticket(s) may be finalized (act 2308) and may enter a “finalize deal” state (act 2310). Otherwise, the portable processing device may stop the timer (act 2312), may enter the “display venue screen” state and may display the venue screen (act 2314).

FIG. 18 shows a state transition from “wait for confirmation” 1810 state to “finalize deal” state 1812 when the portable processing device receives a confirmation.

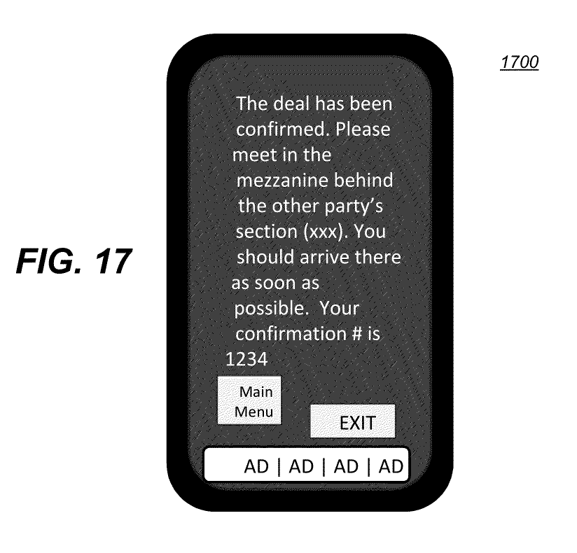

FIG. 17 illustrates exemplary display screen 1700, which the portable processing device may display in various embodiments to inform the user that the deal has been confirmed and where to meet to finalize the deal or complete a transaction.

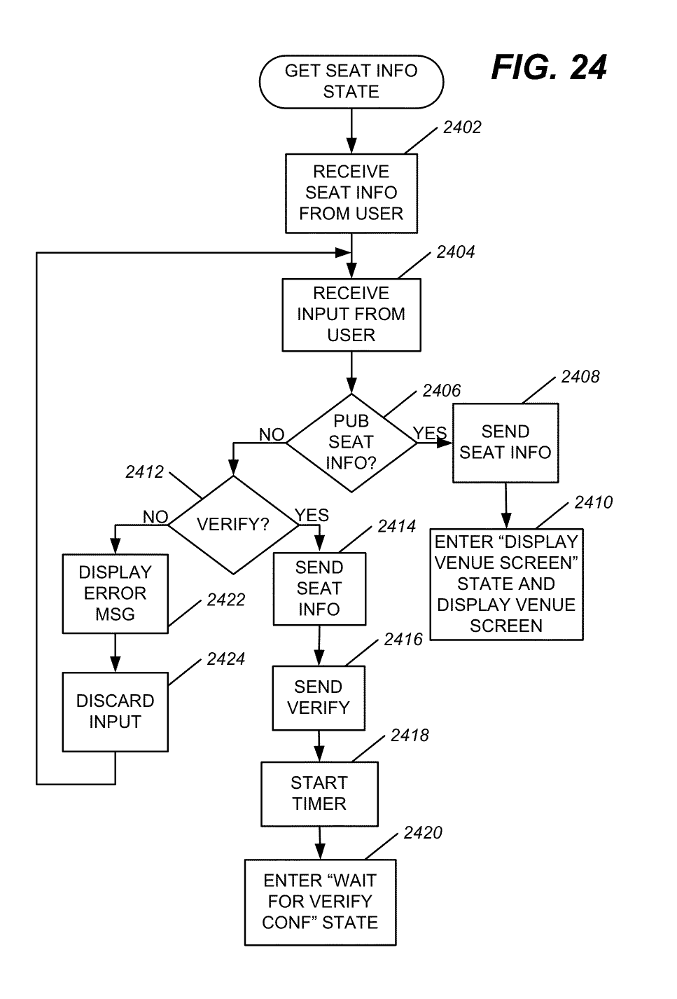

FIG. 24 is a flowchart illustrating exemplary processing of the portable processing device when the portable processing device is in “get seat info” state. The process may begin with the portable processing device receiving provided seat or ticket information from the user of the portable processing device (act 2402). The portable processing device may then receive a second input (act 2404). The received second input may indicate that the provided seat or ticket information is to be published, or made available, to users of other portable processing devices located at a same venue as the portable processing device. If the received second input does indicate that the provided seat or ticket information is to be published, or made available to the users of the other portable processing devices, then the seat or ticket information may be sent from the portable processing device to another processing device, including, but not limited to, a server (2408). The portable processing device may then enter the “display venue screen” state and may display the venue screen (act 2410).

The above is illustrated in the state transition diagram of FIG. 18 by a state transition from “get seat info” state 1814 to “display venue screen” state 1804 when the portable processing device determines that seat information is to be published.

Returning to the flowchart of FIG. 24, if the portable processing device determines, during act 2406, that the second input does not indicate that the provided seat or ticket information is to be published, or made available, then the portable processing device may determine whether the received second input indicates that the seat or ticket information is to be verified (act 2412). If the portable processing device determines that the received second input indicates that the seat or ticket information is to be verified, then the received seat or ticket information may be sent from the portable processing device to the other processing device, including, but not limited to, the server (2414). The user may then use the portable processing device to capture an image of one or more tickets corresponding to the seat or ticket information and may send a copy of the captured image and a request to verify to the other processing device or a third processing device, which may be the server in some embodiments (act 2416).

The portable processing device may then start a timer (act 2418) and may enter “wait for verify confirmation” state to wait for a verify confirmation from the other processing device (act 2420).

The above is illustrated in FIG. 18 by a state transition from “get seat info” state 1814 to “wait for verify confirmation” state 1816 after the portable processing device sends the verify request and the copy of the captured image.

Returning to FIG. 24, if, during act 2412, the portable processing device determines that the received second input does not indicate that the seat or ticket information is to be verified, then the portable processing device may display an error message (act 2422) and may discard the received second input (act 2424).

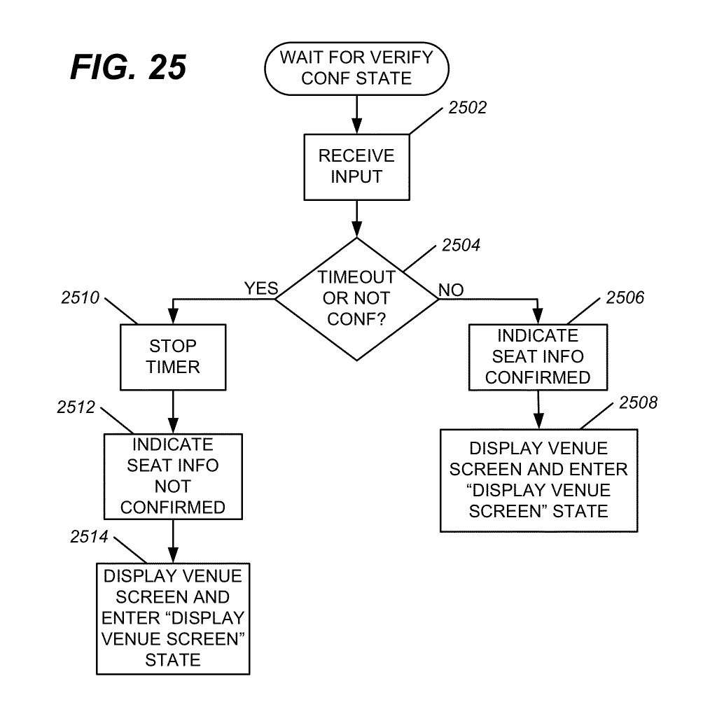

FIG. 25 is a flowchart illustrating exemplary processing by the portable processing device of input from the user while in the “wait for verify confirmation” state. The portable processing device may receive an input (act 2502) and may determine whether the input is a timeout or an indication that ticket(s) are not confirmed as verified (act 2504). If the received input is determined not to be a timeout indication and is determined not to be an indication that the ticket(s) is not confirmed as verified, then the portable processing device may assume that the received input is an indication that a confirmation that the ticket(s) is verified and may display information regarding verification (act 2506). The portable processing device may then enter the display the venue screen and enter the “display venue screen” state (act 2508).

The above exemplary processing is shown in FIG. 18 as a state transition from “wait for verify confirmation” state 1816 to “display venue screen” state 1804 after receiving an indication confirming that the ticket(s) are verified.

If, during act 2504, the portable processing device determines that either the received input is either a timeout indication or an indication that the verify request is not confirmed, then the timer started during act 2418 may be stopped (if not already stopped) (act 2510) and the portable processing device may indicate that the ticket(s) is not verified as confirmed (act 2512). The portable processing device may then display the venue screen and enter the “display venue screen” state (act 2514).

The above exemplary processing is shown in FIG. 18 as a state transition from “wait for verify confirmation” state 1816 to “display venue screen” state 1804 after receiving a timeout indication or an indication that the ticket(s) is not confirmed as being verified.

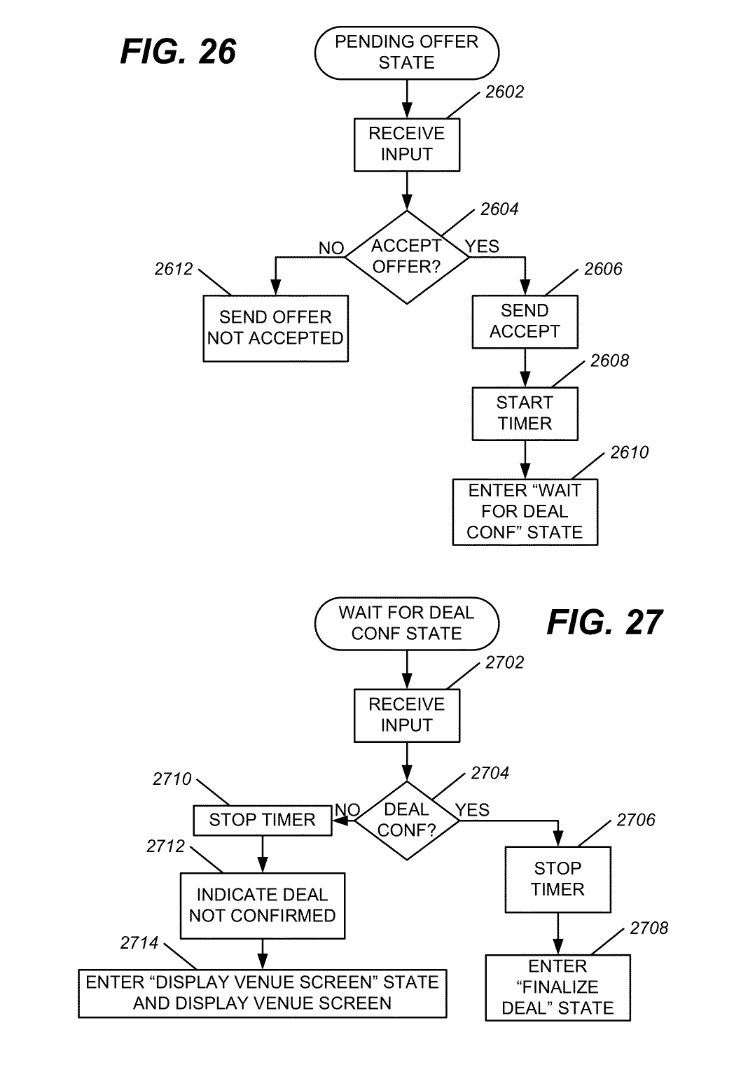

FIG. 26 is a flowchart illustrating exemplary processing of input from the user while the portable processing device is in the “pending offer” state. The portable processing device may receive input from the user while in the “pending offer” state (act 2602) and may determine whether the received input indicates acceptance of a pending offer (act 2604). If the portable processing device determines that the received input indicates acceptance of the pending offer, then the portable processing device may send the acceptance (act 2606).

In some embodiments, the portable processing device may send the acceptance to another processing device, such as, for example, a server. In other embodiments, the portable processing device may send the acceptance directly to a second portable processing device of a second user who made an offer for one or more available tickets offered by the user of the portable processing device.

After sending the acceptance, the portable processing device may start a timer (act 2608) and may enter “wait for deal confirmation” state to wait for an indication that the deal is confirmed (act 2610). In some embodiments, the other portable processing device may send a deal confirmation to the portable processing device to confirm receipt of the acceptance. In other embodiments, the second portable processing device may send the deal confirmation to the portable processing device to confirm receipt of the acceptance.

The state transition diagram of FIG. 18 illustrates the above by a state transition from “pending offer” state 1824 to “wait for deal confirmation” state 1826 after the portable processing device sends an accept indication.

If, during act 2604, the portable processing device determines that the received input is not an indication of acceptance of the offer, then the portable processing device may send an indication that the offer is not accepted (act 2612) and may remain in the “pending offer” state if at least one offer is pending.

In embodiments, in which the portable processing device may send the acceptance to the other processing device, such as, for example, the server, the indication that the offer is not accepted may be sent to the other processing device. In embodiments, in which the portable processing device may send the acceptance directly to the second portable processing device of the second user who made an offer for one or more available tickets offered by the user of the portable processing device, the indication that the offer is not accepted may be sent directly to the second portable processing device.

The state transition diagram of FIG. 18 illustrates the above by sending an indication of no acceptance (“NO ACCEPT”) while remaining in “pending offer” state 1824.

FIG. 27 is a flowchart illustrating exemplary processing by the portable processing device of input from a user while in the “wait for deal confirmation” state. The process may begin with the portable processing device receiving an input from the user while in the “wait for deal confirmation” state (act 2702). The portable processing device may then determine whether the received input indicates a deal confirmation (act 2704). If the received input indicates the deal confirmation, the portable processing device may stop the timer that was started during act 2608 (act 2706) and may enter “finalize deal” state (act 2708).

The above processing is illustrated in the state transition diagram of FIG. 18 by a state transition from “wait for deal confirmation” state 1826 to “finalize deal” state 1812 after receiving an indication of the deal confirmation.

If, during act 2704, the portable processing device determines that the received input does not indicate a deal confirmation, then the portable processing device may stop the timer that was started during act 2608 (act 2710) and may inform the user that the deal is not confirmed (act 2712). The portable processing device may perform act 2712 by displaying a message, providing an audio alert, or via another method. The portable processing device may then enter the “display venue screen” state and may display the venue screen (act 2714).

The state transition diagram of FIG. 18 illustrates the above by showing a transition from “wait for deal confirmation” state 1826 to “display venue screen” state 1804 upon an occurrence of a timeout of the timer or receipt of an indication indicating that acceptance of the pending offer is not confirmed.

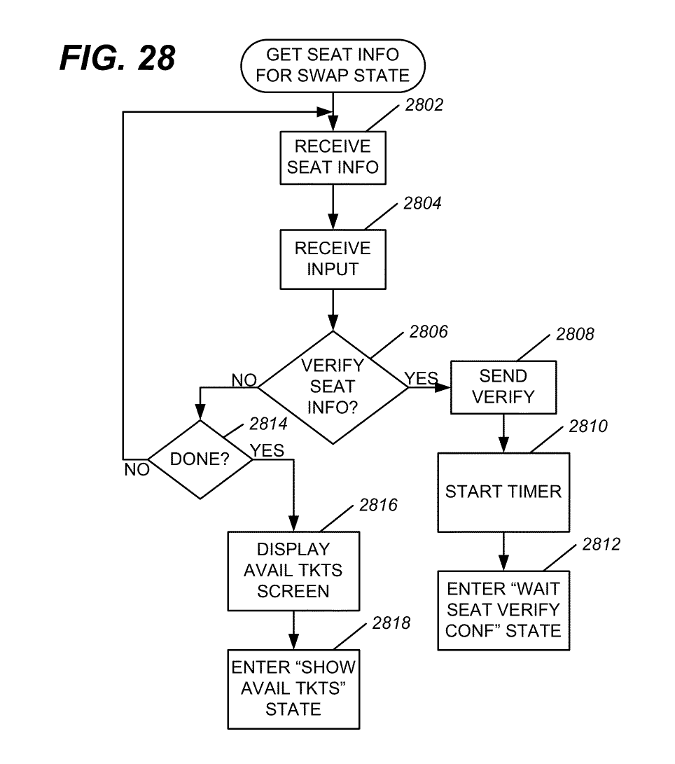

FIG. 28 is a flowchart illustrating exemplary processing of input while the portable processing device is in the “get seat info for swap” state. The process may begin with the portable processing device receiving seat or ticket information from the user of the portable processing device while in the “get seat info for swap” state (act 2802). After the seat or ticket information is provided, the portable processing device may receive a second input from the user (act 2804) and may determine whether the second input is an indication to verify the received seat or ticket information (act 2806).

If the portable processing device determines that the received second input is the indication to verify the received seat or ticket information, then the user may employ the portable processing device to capture an image of one or more tickets corresponding to the seat or ticket information and may send the captured image and a verify request to another processing device, such as, for example, a server (act 2808). The portable processing device may then start a timer (act 2810) and may enter “wait seat verify confirmation” state to wait for a confirmation from the other processing device that the one or more tickets are verified (act 2812).

The state transition diagram of FIG. 18 illustrates the above by a state transition from “get seat info for swap” state 1818 to “wait seat verify confirm” state 1820 after sending a verify request.

Returning to FIG. 28, if, during act 2806, the portable processing device determines that the received second input is not an indication that the received seat or ticket information is to be verified, then the portable processing device may determine whether the received second input is an indication that inputting of the received seat information is completed (act 2814). If the portable processing device determines that the received second input is an indication that inputting of the received seat information is completed, then the portable processing device may display the available tickets screen (act 2816) and may enter “show available tickets” state (act 2818). Otherwise, acts 2802-2806 may be repeated.

The state transition diagram of FIG. 18 illustrates the above by a state transition from “get seat info for swap” state 1818 to “wait seat verify confirmation” state 1820 after receiving and sending a verify request, and a state transition from “get seat info for swap” state 1818 to “show available tickets” 1822 state upon receiving an indication that inputting of the seat or ticket information is completed.

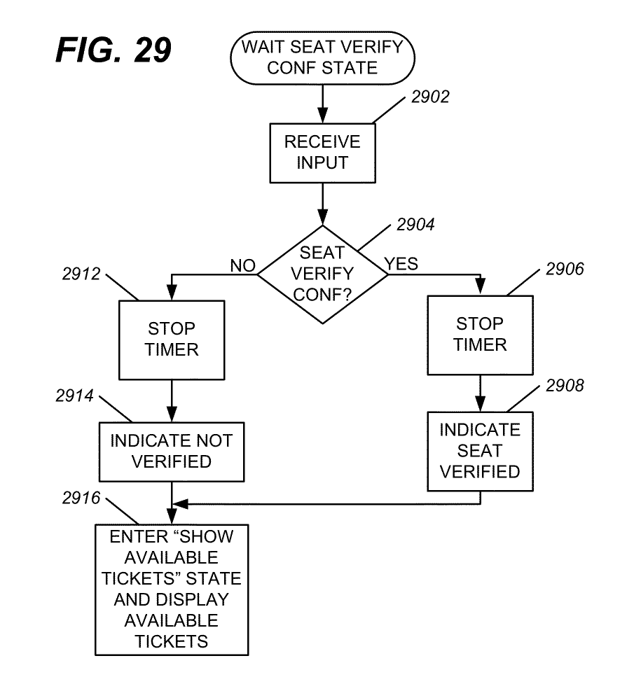

FIG. 29 is a flowchart illustrating exemplary processing by the portable processing device of input from a user while in the “wait seat verify confirmation” state. The process may begin with the portable processing device receiving an input from the user while the portable processing device is in the “wait seat verify confirmation” state (act 2902). The portable processing device may then determine whether the received input is a seat verify confirmation confirming verification of one or more seats or tickets (act 2904).

If the portable processing device determines that the received input is the seat verify confirmation, then the portable processing device may stop the timer that was started previously, when the request for verification was sent (act 2906), and may provide an indication that the one or more seats or tickets are verified (act 2908). The indication may be a message displayed by the portable processing device, a sound made by the portable processing device, or other type of indication by the portable processing device. The portable processing device may then enter the “show available tickets” state and may display available tickets (act 2916).

The above is illustrated in the state transition diagram of FIG. 18 by a state transition from “wait seat verify confirmation” state 1820 to “show available tickets” state 1822 after an indication is received confirming that the one or more seats or tickets are verified.

If, during act 2904, the portable processing device determines that the received input is not the indication that the one or more seats or tickets are verified, then the portable processing device may stop the timer that was started previously when the request for verification was sent (act 2912) and may provide an indication that the one or more seats or tickets are not verified (act 2914). The portable processing device may then enter the “show available tickets” state and may display the available tickets (act 2916).

The state transition diagram of FIG. 18 illustrates acts 2912-2916 by a transition from “wait seat verify confirm” state 1820 to “show available tickets” state 1822 upon receiving an indication that the one or more tickets are not confirmed as being verified or upon receiving an indication of a timeout of the timer that was started when the request for verification was sent.

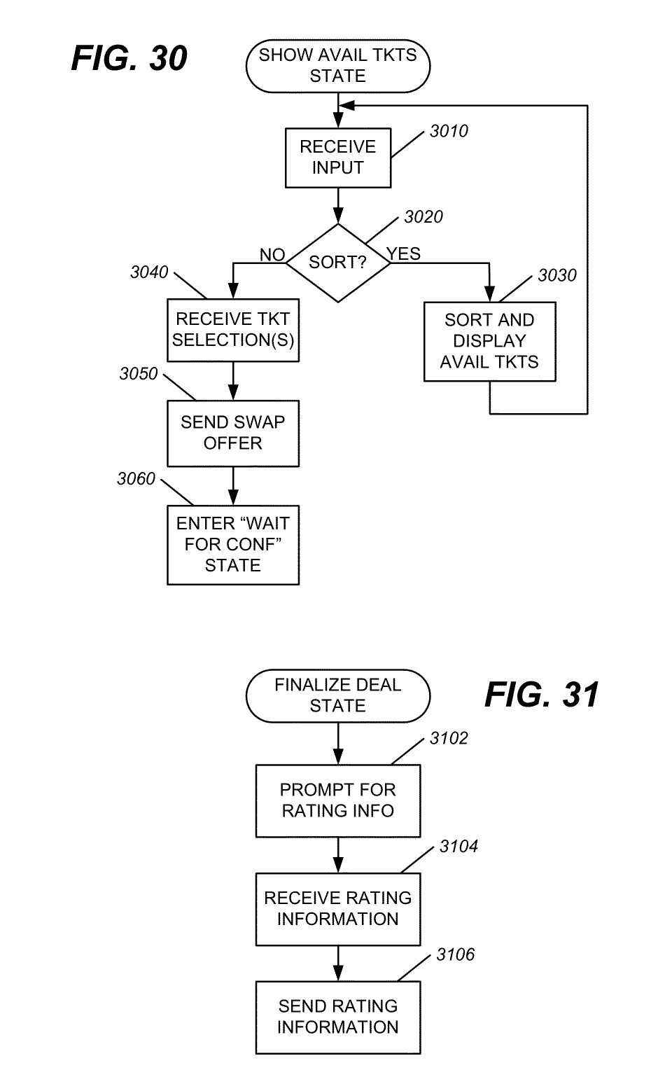

FIG. 30 is a flowchart illustrating exemplary processing by the portable processing device of input from a user while in the “wait seat verify confirmation” state. The process may begin with the portable processing device receiving an input (act 3010). The portable processing device may then determine whether the input is a request for sorting a displayed list of available tickets (act 3020). If the portable processing device determines that the input is a request for sorting, then the portable processing device may sort the displayed list of available tickets according to a selected order and may display the sorted list of available tickets (act 3030).

The above is illustrated in the state transition diagram of FIG. 18 by remaining in “show available tickets” state 1822 upon receiving the request for sorting.

If, during act 3020, the portable processing device determines that the received input is not a sort request, then the portable processing device may receive one or more seat or ticket selections (act 3040), may send a swap offer regarding the one or more received seat or ticket selections (act 3050) and may enter the “wait for confirmation” state (act 3060).

The above is illustrated in the state transition diagram of FIG. 18 by a state transition from “show available tickets” state 1822 to “wait for confirmation” state 1810 after sending the swap offer.

In various embodiments, the portable processing device may send a swap offer to a second processing device, which may be a server, and may expect to receive a confirmation from the server. The second processing device may then provide the swap offer to other portable processing devices, located within a predetermined distance of a venue in which the portable processing device, that request information regarding available seats or tickets. In some embodiments, the second processing device may send the swap offer to ones of the other portable processing devices only when the ones of the portable processing devices request information regarding one or more available seats or tickets.

FIG. 31 is a flowchart illustrating exemplary processing while in the “finalize deal” state. The process may begin with the portable processing device prompting the user for rating information regarding a deal (act 3102). The prompt may be presented to the user via a display screen of the portable processing device. The portable processing device may then receive rating information from the user (act 3104). The rating information may include, but not be limited to, a grade or numerical score provided by the user as well as other information. The portable processing device may send the rating information to the second processing device (act 3106). FIG. 18 illustrates the above by showing that no state transition occurs in “finalize deal” state 1812 when the portable processing device receives rating information while in “finalize deal” state 1812. At a later time, users of portable processing devices may request, receive and display rating information regarding deals offered by various users.

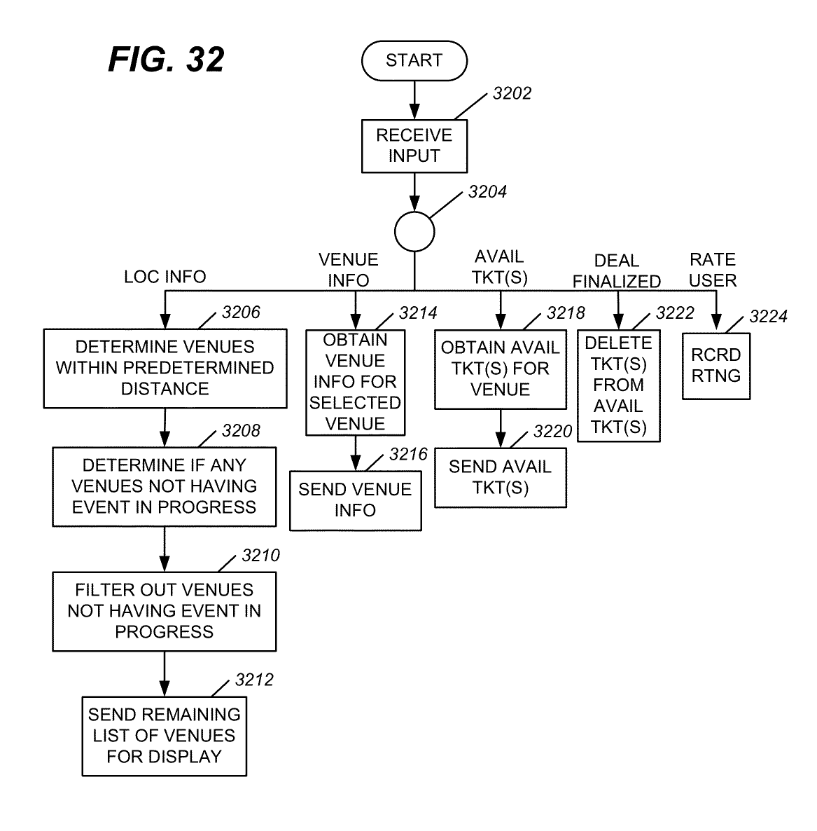

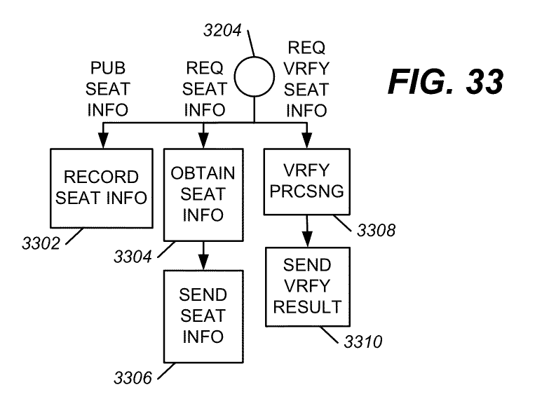

FIGS. 32-33 are flowcharts illustrating exemplary processing of a server in some embodiments consistent with the subject matter of this disclosure. The process may begin with the server receiving an input from a portable processing device (act 3202). The server may then determine a type of the input (act 3204). If the type of the input is determined to be location information, the server may determine one or more venues within a predetermined distance of a location as indicated by the location information (act 3206).

The server may then determine if any of the one or more venues do not currently have an event in progress (act 3208). In some embodiments, an event may be considered to be in progress if a current time is a time after a starting time of an event and is before a scheduled or estimated ending time of the event. In other embodiments, an event may be considered to be in progress if the current time is a time that is no earlier than a predetermined time period before the starting time of the event and is no later than the scheduled or estimated ending time of the event. In further embodiments, an event may be considered to be in progress according to other criteria.

After determining whether any of the one or more venues do not have an event in progress, the server may filter out any venues not having an event in progress from the one or more venues, thereby producing a list of remaining venues (act 3210). The server may then send the list of remaining venues to the portable processing device from which the location information was received (act 3212).

If, at act 3204, the server determines that the input indicates a selection of a venue, then the server may obtain venue information for the selected venue (act 3214) and may send the venue information to the portable processing device (act 3216).

If, at act 3204, the server determines that the input is a request for available, or offered, tickets, then the server may obtain information regarding the available, or offered, tickets (act 3218) and may send the obtained information to the portable processing device (act 3220).

If, during act 3204, the server receives an indication indicating a deal is finalized, the server may delete information regarding available tickets corresponding to the tickets of the finalized deal (act 3222).

If, during act 3204, the server receives information regarding a rating of a user, the server may record the information (act 3224). At a later time, the server may provide a report to users regarding users' ratings.

If, during act 3204, the server receives seat information, including a request to publish the seat information, the server may record the seat information (act 3302; FIG. 33). The seat information may be made available to users of portable processing devices who request the seat information.

If, during act 3204, the server receives a request for seat information with respect to a venue, the server may obtain the requested seat information (act 3302). The seat information may then be sent to a requesting portable processing device (act 3306).

If, during act 3204, the server receives a request to verify seat information, along with a captured image of one or more corresponding tickets, the server may perform verify processing on the captured image (act 3308). In various embodiments, the verify processing may include verifying that the captured image of the one or more corresponding tickets includes one or more features by which the captured image may be verified. The server may send verify processing results to a requesting portable processing device (act 3310).

### Miscellaneous

Various other features may be included in other embodiments consistent with the subject matter of this disclosure. For example, in some embodiments, a user of a portable processing device may request and receive information concerning an estimated probability that an offer regarding a particular seat, or seats, will be accepted. The probability may be estimated based on a seating position of the particular seat, or seats, as well as other information, including, but not limited to, a number of seats, or tickets, not sold for an event. The estimated probability may be presented via a display of the portable processing device, via synthesized speech, or via other methods.

In other embodiments, a user of the portable processing device may request that offers to swap a first seat for a second seat, which is considered to be worse than the first seat, be filtered out, or not presented, by the portable processing device.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. Further, implementations consistent with the subject matter of this disclosure may have more or fewer acts than as described with respect to FIGS. 19-33, or may implement acts in a different order than as shown. Accordingly, the appended claims and their legal equivalents define the invention, rather than any specific examples given.

I claim as my invention:

1. A machine-implemented method comprising:
receiving, by a portable processing device, location information regarding a current location of the portable processing device;
displaying at least one venue within a predetermined distance of the current location as indicated by the received location information;
receiving, by the portable processing device from a user, a selection of one of the at least one displayed venue;
receiving, by the portable processing device from the user, seat information regarding at least one seat of the user at the selected one of the at least one displayed venue;
publishing, by the portable processing device, the seat information such that the seat information is available to at least one other portable processing device located within a predetermined distance of the selected one of the at least one displayed venue;
receiving and displaying, via the portable processing device, at least one offer regarding the at least one seat of the user; and
accepting, by the user via the portable processing device, one of the at least one offer regarding the at least one seat of the user.

2. The machine-implemented method of claim 1, wherein the receiving the seat information is permitted only at a time while an event is in progress at the selected one of the at least one displayed venue.

3. The machine-implemented method of claim 1, wherein the publishing the seat information is allowed only at a time while an event is in progress at the selected one of the at least one displayed venue.

4. The machine-implemented method of claim 1, wherein one of the at least one offer includes at least one item from a group of items consisting of an offer to swap at least one other seat for the at least one seat of the user and an offer of an amount of money for the at least one seat of the user.

5. The machine-implemented method of claim 1, wherein the location information regarding a current location of the portable processing device is determined based on communicating with a global positioning satellite system or is determined based on scanning signals for unique signatures from at least one wireless fidelity access point.

6. The machine-implemented method of claim 1, the location information regarding a current location of the portable processing device is manually provided by the user via the portable processing device.

7. The machine-implemented method of claim 1, further comprising:
capturing, by the portable processing device, an image of at least one ticket corresponding to the at least one seat of the user; and
providing, by the portable processing device, the image of the at least one ticket for verification processing.

8. The machine-implemented method of claim 1, further comprising:
determining at least one nearby venue within the predetermined distance of the current location;
determining whether ones of the at least one nearby venue have a corresponding event in progress, wherein
the displaying at least one venue within a predetermined distance of the current location as indicated by the received location information further comprises:
displaying only ones of the at least one nearby venue determined to have the corresponding event in progress.

9. The machine-implemented method of claim 1, further comprising:
displaying, by the portable processing device, information pertaining to an event in progress at the selected one of the at least one displayed venue in response to receiving a request from the user.

10. The machine-implemented method of claim 9, wherein the information pertaining to the event includes at least one item selected from a group of items consisting of a seating chart and a roster of participants in the event.

11. A portable processing device comprising:
at least one processor;
a wireless communication interface;
a memory; and
a bus connecting the at least one processor with the wireless communication interface and the memory, the memory including instructions for the at least one processor to perform a method comprising:
receiving location information regarding a current location of the portable processing device;
displaying at least one venue within a predetermined distance of the current location of the portable processing device;
receiving a selection of one of the at least one displayed venue;
receiving available seat information published by a second portable processing device located within the predetermined distance of the selected one of the at least one displayed venue;
displaying the published available seat information;
receiving, from a user of the portable processing device, an offer for at least one seat corresponding to the published available seat information;
sending the offer to the second portable processing device; and
receiving either an acceptance or a rejection of the offer from the second processing device.

12. The portable processing device of claim 11, wherein the offer includes at least one of an offer of an amount of money and an offer for swapping seats.

13. The portable processing device of claim 11, further comprising:
receiving a plurality of available seat information published by a plurality of portable processing devices located within the predetermined distance of the selected one of the at least one displayed venue;
displaying the plurality of available seat information; and
sorting an order of a presentation of the displayed plurality of available seat information based on a sort order indication received from the user.

14. The portable processing device of claim 11, further comprising:
receiving seat information from the user;
capturing an image of at least one ticket corresponding to the seat information from the user; and
sending the image of the at least one ticket for ticket verification.

15. The portable processing device of claim 11, further comprising:
receiving a plurality of available seat information published by a plurality of portable processing devices located within the predetermined distance of the selected one of the at least one displayed venue; and
displaying at least some of the plurality of available seat information, unverified tickets corresponding to ones of the received plurality of available seat information being filtered out from being displayed.

16. The portable processing device of claim 11, further comprising:
permitting the user of the portable processing device to rate a second user of another portable processing device based on a completed accepted offer.

17. The portable processing device of claim 11, wherein:
the offer includes an offer for swapping seats, and
the method further comprises:
estimating a probability of the offer being accepted based on a location of the seats, and
displaying the estimated probability of the offer being accepted.

18. The portable processing device of claim 11, wherein the method further comprises:
providing a user interface for the user to request filtering out of offers to swap a seat when the offered seat is considered to be worse that a current seat of the user.

19. A system comprising:
at least one server having at least one processor, a communication interface for communicating with at least one portable processing device, and a memory having instructions recorded therein for the server to perform a method, the at least one processor being connected with the communication interface and the memory, the instructions recorded in the memory causing the at least one processor to perform a method comprising:
receiving seat information from a portable processing device, located within a predetermined distance of a venue, regarding at least one seat at an event currently in progress at the venue;
providing the received seat information as an offer to at least one other portable processing device located within the predetermined distance of the venue;
receiving an acceptance of the offer from one of the at least one other processing device; and
providing instructions to the one of the at least one other processing device and the portable processing device for completing the acceptance of the offer.

20. The system of claim 19, wherein the providing the received seat information is performed only while the event is in progress.
